(19) United States
(12) Patent Application Publication
(10) Pub. No.: US 2007/0049766 A1
(43) Pub. Date: Mar. 1, 2007

(54) Synthesis of tetrakis(dialkylamino)silanes

(76) Inventors: John A. Belot, Lincoln, NE (US); Chiranjib Banerjee, Lincoln, NE (US)

Correspondence Address: MILES & STOCKBRIDGE PC, 1751 PINNACLE DRIVE, SUITE 500, MCLEAN, VA, 22102-3833, US

(21) Appl. No.: 11/447,309

(22) Filed: Jun. 6, 2006

Related U.S. Application Data
(60) Provisional application No. 60/687,826, filed on Jun. 6, 2005.

(51) Int. Cl. C07F 7/02

(52) U.S. Cl. 556/400; 556/410

(57) ABSTRACT

A method of synthesizing a substantially pure homoleptic tetrakis secondary amine derivative of silicon, said derivative being substantially free of halogen and having the formula:
Si(NRR¹)₄
wherein: R and R¹ are the same or different and are substituted or unsubstituted straight or branched chain alkyl, groups having from 1 to 6 carbon atoms, said method comprising reacting a silicon halide having the formula:
   SiX₄ wherein: X is bromine or iodine, with an excess of a secondary amine having the formula:
   HNRR¹
wherein: R and R¹ are as defined as above,
   for a time and under conditions sufficient to produce a reaction product mixture containing the desired product, Si(NRR¹)₄.

The present invention relates to novel methods for the synthesis of certain silanes useful in thin film fabrication, variant atomic layer deposition and semiconductor research. The complete disclosures and contents of each patent and literature reference cited herein are incorporated herein by reference. This work was supported in part by the MRSEC Program of the National Science Foundation under Award Number DMR-021380 and NSF CHE-0415928.

### BACKGROUND OF THE INVENTION

Chemical vapor deposition (in its many forms) and its related variant atomic layer deposition are accepted thin film fabrication techniques at semiconductor research and production levels [see U.S. Pat. Nos. 5,258,229; 5,258,224; 5,209,979; 5,208,284; 5,173,367and 4,346,468.] Essential to all of these various processes is the availability of high-purity chemical sources that display appropriate chemistry and appreciable volatility [A. C. Jones, 1.Mater. Chem. 12 (2002) 2576-2590 and M. Leskela, M. Ritala, Thin Solid Films 409 (2002) 138-146]. One general precursor class that has recently generated significant commercial [A. S. Borovik, C. Xu, B. C. Hendrix, I. F. Roeder, T. H. Baum, Mat. Res. Soc. Symp. Proc. 716 (2002) 113-117] and scientific [N. W. Mitzel, Angew. Chem. Int. Ed. 38 (1999) 86-88] interest are hetero- and homo-leptic pnictogenyl compounds of group 14 elements, of which tetrakis(dialkylamino)silanes are an important subset.

These compounds, recognized to always contain various levels of halide impurity typically resulting from incomplete amination of the SiCl₄ starting material [A. S. Borovik, C. Xu, B. C. Hendrix, I. F. Roeder, T. H. Baum, Mat. Res. Soc. Symp. Proc. 716 (2002) 113-117; V. Passarelli, G. Carta, G. Rossetto, P. Zanella, Dalton Trans. (2003) 413-419; X. Liu, X. Pu, H. Li, F. Qiu, L. Huang, Mater. Lett. 59 (2005) 11-14 and X-J Liu, Y-F. Chen, H. L. Li, X. W. Sun, L-P. Huang, Thin Solid Films 479 (2005) 137-143], are under active exploration as silicon sources for binary oxides (SiO₂) and higher-order silicates such as ZrₓSi₁₋ₓO₂ and HfₓSi₁₋ₓO₂ [T Maruyama, T Shirai, Appl. Phys. Lett. 63 (1993) 611-613; B. C. Hendrix, A. S. Borovik, C. Xu, I. F. Roeder, T. H. Baum, M. I. Bevan, M. R. Visokay, J. J. Chambers, A. L. P. Rotondaro, H. Bu, L. Colombo, Appl. Phys. Lett. 80 (2002) 2362-2364 and Y. Ohshita, A. Ogura, M. Ishikawa, T. Kada, H. Machida, Jpn. J. Appl. Phys. 42 (2003) L578-L580].

Apart from their use as gate dielectric precursors in vapor and liquid delivery solutions, they have also been considered promising metal-organic sources for IV/V films; specifically for the growth of amorphous silicon nitride [X. Liu, X. Pu, H. Li, F. Qiu, L. Huang, Mater. Lett. 59 (2005) 11-14; X-J Liu, Y-F. Chen, H. L. Li, X. W. Sun, L-P. Huang, Thin Solid Films 479 (2005) 137-143 and R. G. Gordon, D. M. Hoffman, U. Riaz, Chem. Mater. 2(1990) 480-482]. whose expanding applications range from semiconductor diffusion barriers and passivation layers to antireflection coatings on silicon solar cells. Regardless of the final application, minimizing halide content in the tetrakis(dialkylamino)silanes is essential, because their presence complicates process conditions or ultimately leads to device failure through the introduction of charge carriers or possibly even etching of the native silicon foundation.

It is an object of the present invention to provide a novel synthesis of substantially halogen-free tetrakis(dialkylamino)silanes.

### SUMMARY OF THE INVENTION

The above and other objects are realized by the present invention, one embodiment of which relates to a method of synthesizing a substantially pure homoleptic tetrakis secondary amine derivative of silicon, the derivative being substantially free of halogen and having the formula:
Si(NRR¹)₄ [1]
wherein: R and R′ are the same or different and are substituted or unsubstituted straight or branched chain alkyl, groups having from 1 to 6 carbon atoms,
   the method comprising reacting a silicon halide having the formula:
   SiX₄
wherein: X is bromine or iodine,
   with an excess of a secondary amine having the formula:
   HNRR¹
wherein: R and R′ are as defined as above,
   for a time and under conditions sufficient to produce a reaction product mixture containing the desired product, Si(NRR¹)₄.

A further embodiment of the invention concerns halogen-free, substantially pure Si(NRR¹)₄.

Another embodiment of the invention relates to a precursor composition for forming a silicon-containing layer on a substrate, the precursor composition comprising halogen-free, substantially pure Si(NRR¹)₄.

Still another embodiment of the invention relates to a silicon-containing layer made from the above-described composition.

A still further embodiment of the invention relates to an improved substrate having a silicon-containing layer formed thereon using a silicon precursor, the improvement wherein the silicon precursor is substantially halogen-free, pure Si(NRR¹)₄.

An additional embodiment of the invention concerns an improved method of forming a layer comprising a silicon-containing material using a silicon precursor, the improvement wherein the silicon precursor is substantially halogen-free, pure Si(NRR¹)₄.

An additional embodiment of the invention concerns a microelectronic device structure comprising the above-described substrate.

### BRIEF DESCRIPTION OF THE DRAWING

FIG. 1 is a TDA analysis of a product of the invention.

### DETAILED DESCRIPTION OF THE INVENTION

The present invention is predicated on the discovery that halogen-free, substantially pure tetrakis(dialkylamino)silanes may be prepared by utilizing silicon bromides and iodides as reactants rather than the chlorides typically employed in prior art processes. The method of the invention may be conducted in the substantial presence or absence of a reaction solvent. The method is preferably carried out wherein the molar ratio of the secondary amine to the silicon halide is greater than 1:1

Where the reaction product mixture also contains the insoluble by-product, 4[X⁻(H₂NR¹R)⁺] and excess secondary amine, the desired product may be separated therefrom by (1) filtration to remove the [X−(H₂NR¹R)+] and (2) distillation, e.g., reduced pressure distillation, to remove the excess secondary amine.

The preferred products of the invention embraced by formula [I] are those wherein

R═R¹=methyl, R═R¹=ethyl and R=methyl and R¹=ethyl. In any event the products of the invention are characterized by their substantial purity, and, more particularly, by the substantial absence of halogen(s) therein.

The products of the invention are extremely valuable as precursor compositions for forming silicon-containing layers on substrates. Such silicon-containing layers include, but are not limited to silicon, silicon nitride, silicon dioxide, doped silicon dioxide, low dielectric constant material, silicon-oxy-nitride and the like. The layers may be formed on desired substrates by, e.g., vapor deposition techniques.

Improved microelectronic device structures comprising the products of the invention include, but are not limited to microelectronic device structures, e.g., a semiconductor integrated circuit, gate oxide, high k dielectric, low k dielectric, barrier layer, etch stop layer, gate spacer, gate dielectric, silicon nitride barrier layer, semiconductor device, field effect transistor, metal oxide semiconductor capacitor and the like.

In an effort to better understand and address the problematic halide content that plagued previous preparations, there was initiated a synthetic study to both determine product distributions and evaluate routes toward halide-free homoleptic complexes using three different amino ligands: dimethylamino (DMA), diethylamino (DEA), and ethylmethylamino (EMA), all of which are commonly used ligands in commercial precursor design [A. C. Jones, 1. Master. Chem. 12 (2002) 2576-2590]. Initial efforts followed the methods and schemes of the prior art and involved the use of SiCl₄ and the lithium salts of DMA and DEA as well as the free amine, EMA, although employing higher aromatic hydrocarbon boiling solvents than those previously reported [Leskala et al and Gordon et al, supra]. In every attempted experiment, the chloride content could not be reduced below that of the monochlorosilane. For a number of reasons, efforts were then shifted to the heavier halide starting materials SiBr₄ and SiI₄.

The primary motivation for using the heavier halides was to exploit the decreasing Si—X bond strengths when compared to Si—Cl. It was felt this would be particularly important and advantageous in achieving complete amination if the substitution steps involved a dissociative mechanism, as proposed by Passarelli et al, supra, further facilitated by anomeric effects [V. F. Sidorkin, V. A. Shagun, V. A. Pestunovich, Russ. Chem. Bull. 48 (1999) 1049-1053] of the nitrogen lone-pair [J. Mack, C. H. Yoder, Inorg. Chem. 8 (1969) 278-281 and D. G. Anderson, A. J. Blake, S. Cradock, E. A. V. Ebsworth, D. W. H. Rankin, A. J. Welch, Angew. Chem. Int. Ed. Eng. 25 (1986) 107-108]. Secondarily, both the HBr and HI by-products of the reactions are slightly stronger acids than HCl, driving the non-aqueous acid-base equilibrium with excess amine further forward toward the ammonium precipitate, X⁺H₂NR₂ [H. H. Anderson, 1. Am. Chem. Soc. 74 (1952) 1421-1423]. Ultimately, the steric bulk of the halide versus the incoming amine may also be important since recombination of any proposed cationic intermediate [Passarelli et al] with the larger halide anions will be less favored with bulkier amino alkyl groups [H. Breederveld, H. I. Waterman, Research 5 (1952) 537-539; H. Breederveld, H. I. Waterman, Research 6 (1953) 1S-3S and G. Huber, A. lockisch, H. Schmidbaur, Eur. 1. Inorg. Chem. (1998) 107-112].

Referring to Scheme 1, below, the first attempt (1) using either SiBr4 or SiI4 with Li+−N(CH3h (since dimethyl amine is a gas we chose the alkali metal salt) afforded the desired homoleptic Si(DMA)4 in >70% yield and analytical purity after a simple reduced pressure distillation. This confirmed the hypothesis that the weaker Si—Br or Si—I bonds could afford the desired homoleptic compounds without halide residue (see Scheme 1).

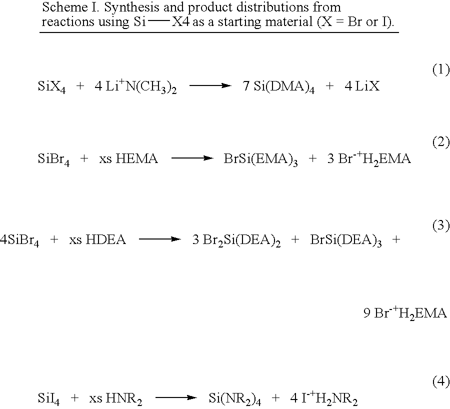

Following this success the reactions between SiBr4 and both protio HEMA and HDEA amines in toluene were evaluated. For the reactions with HEMA (2) only the monobromo silane compound, BrSi(EMA)₃, was isolated from distillation (after removing the precipitate) in >80% yield and analytical purity, even if 128 equivalents of HEMA were used with respect to SiBr₄. The reaction with HDEA (3) immediately became more complex, and purification of the crude products yielded Br₂Si(DEA)₂ and BrSi(DEA)₃ in a 3:1 molar ratio. In attempts to drive these reactions to completion, all purified halogen-containing products were subjected to a neat reflux in the parent amine starting material. For BrSi(EMA)₃ and BrSi(DEA)₃ no reaction was observed, and only the monobromosilanes were reisolated. However, prolonged reflux (>24 h) of Br₂Si(DEA)₂ in excess HDEA did ultimately remove a single bromide ion and provide nearly quantitative conversion to BrSi(DEA)₃.

In an analogous approach to (2) and (3) the reactions between SiI₄ and HEMA and HDEA were explored (4). It was found that the homoleptic products could be isolated in excellent yields and high-purity by first removing the ammonium precipitates by filtration through a filter aid followed by a simple vacuum distillation. The isolated yields of the colorless Si(DMA)₄, Si(EMA)₄, and Si(DEA)₄ liquids were 70%, 80%, and 88%, respectively. The purified products never exhibited residual halide (ICP-MS and elemental analysis) and were, for the first time, fully characterized by common spectroscopic methods including mass spectroscopy and elemental analysis.

To assess stability the propensity for homoleptic aminosilane alcoholysis with both MeOH and EtOH was explored using ¹H and ¹³C NMR to monitor the reaction. Surprisingly none of the tetrakis(dialkylamino)silanes reacted with either dried alcohol at ambient temperature and failed to undergo any significant spectroscopic changes at elevated temperatures (˜40 0c) over a period of 8 hours. These observations were attributed to a strong, robust S—N bond and significant steric crowding around the Si center. Although stable toward small alcohols, the complexes were found to undergo hydrolysis at ambient temperature, with each being completely consumed by H₂O within 30 min at the rate Si(DMA)₄>Si(EMA)₄>Si(DEA)₄. Qualitatively, at elevated temperatures the hydrolysis occurs more rapidly. No attempts were made to identify or analyze the final products from these reactions, however they lend credence to the technique of effectively using H₂O as a coreactant in both vapor phase and solution (sol-gel) processing of these compounds.

One of the requirements for vapor phase processing and film growth is volatility. The boiling point of each compound increases with increasing amino steric bulk. At 0.15 Torr the boiling point ranges of Si(DMA)₄, Si(EMA)₄, and Si(DEA)₄ are 20-22° C., 68-70° C. and 120-123° C., respectively. Thus, the addition of one ethyl group to each amine elevates the boiling point by approximately 50° C.

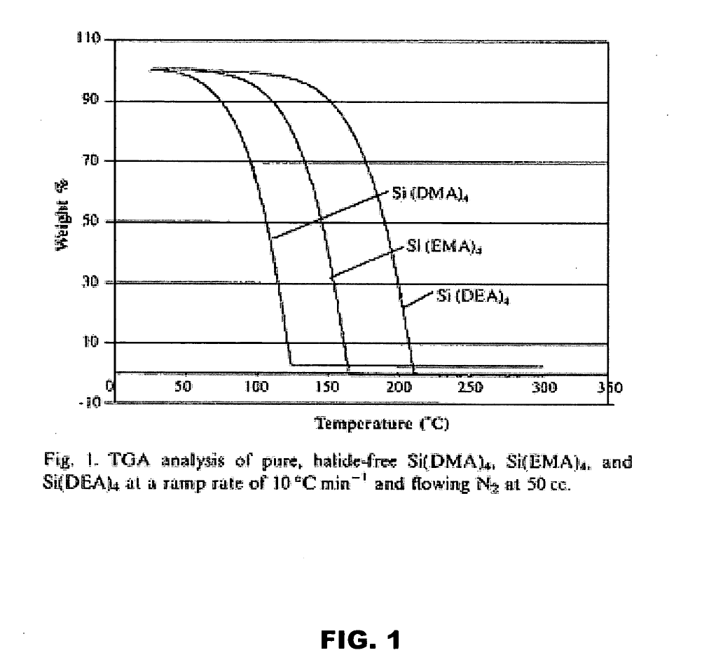

Atmospheric pressure thermogravimetric analysis (TGA, FIG. 1, ramp rate 10 ° C. min⁻¹ under 50 cc flowing N₂) reveals that both Si(EMA)₄ and Si(DEA)₄ volatilize to 0% residue, indicating complete evaporation and negligible decomposition. Although ≈2% residue remains for Si(DMA)₄, this is most likely due to a handling artifact, since this compound undergoes the fastest hydrolysis.

In summary, the present invention enables definitive, high-yield, and straight forward syntheses and complete characterization of homoleptic, volatile tetrakis(dialkylamino)silane derivatives, e.g., Si(DMA)₄, Si(EMA)₄, and Si(DEA)₄. The reaction between SiBr4 and the amine starting materials failed to give the desired compounds by equations (2) and (3), but ultimately and repeatedly yielded monobromosilanes of the general formula BrSi(NR₂)₃ directly or by neat reflux with excess amine. However, switching to the heavier halide starting material, SiI4, completely avoided mixed halide-amino species, and the title compounds presented themselves in high-yields and analytical purity (4). The reactions of either SiBr₄ or SiI₄ with Li⁺⁻N(CH₃)₂ afforded only the homoleptic complex Si(DMA)₄ Furthermore, it was discovered that the amino complexes do not undergo appreciable alcoholysis at ambient or elevated temperatures but do slowly hydrolyze upon exposure to H²O, rendering them reactive and useful reagents for both vapor and solution phase processing.

### EXAMPLE 1

### Tetrakis(dimethylamino)silane

SiBr₄ (10.2925 g., 29.6 mmol) in 40 mL dry C₇H₈ was added dropwise to a slurry of LiNMe₂ (10 g., 196 mmol) in 100 mL dry C₇H₈ at O° C. After warming to room temperature, the mixture was heated at reflux for 24 h and then filtered through Celite. Both the flask and the precipitate were washed with pentane (30 mL) and the washings combined with the mother liquor. The volatiles were removed under dinitrogen and the light yellow crude product purified by vacuum distillation to give a colorless liquid of Si(NMe₂)₄ (2.82 g, yield: 70%, b.p.

20-22° C. at 0.15 Torr). ¹H NMR (C₆D₆) δ 2.5 (singlet); ¹³C NMR (C₆D₆)δ 38.6 (singlet); IR (neat, cm⁻¹) 2972 (br, s), 1463 (m), 1291 (s), 1179 (s), 1069 (m), 987 (vs), 724 (s), 444 (m); Elemental Anal.: Calc. C, 47.01%; H, 11.84%; N, 27.41%; Observed. C, 47.24%; H, 11.79%; N, 27.53%. HR-EI M.S.: Calcd. mol. wt. 204.39, observed mol. wt. 204.177.

### EXAMPLE 2

### Tetrakis(diethylamino)silane and tetrakis(ethylmethylamino)silane

In a representative procedure the amine was first dried overnight over CaH₂ and the freshly distilled immediately before use. 12 mol. excess of amine was added to 23 mmol of SiI₄, stirring in 130 mL of dry C₇H₈ in a 2-neck flask fitted with a reflux condenser and a septa. The reaction was then heated at reflux for 24 h and a white precipitate of R₂NH₂⁺I⁻ salt formed upon cooling the solution to room temperature. The white precipitate was filtered through Celite, washed with C₅H₁₂ and the washings combined with the filtrate. The volatiles were removed under dinitrogen and the crude products purified by vacuum distillation to give colorless tetrakis(dialkylamino)silanes

Tetrakis(ethylmethylamino)silane [Si(NEtMe)₄]—Yield: 80%; b.p. 68-70° C. at 0.15 Torr; ¹H NMR (C₆D₆) δ 1.06, (triplet, 3H), 2.503 (singlet, 3H); 2.81 (quartet, 2H); ¹³C NMR (C₆D₆) δ 15.0, 35.0, 44.7; IR (neat, cm⁻¹) 2965 (br, s), 1473 (m), 1371 (ms), 1232 (s), 1175 (s), 1060 (m), 1007 (vs), 912 (s), 789 (m), 697 (s), 492 (m); Elemental Anal.: Calc.: C, 55.33%; H, 12.38%; N, 21.51%; Observed. C, 55.21%; H, 12.17%; N, 21.63%; HR-EI M.S.: Calcd. Mol. Wt. 260.5, observed mol. wt. 260.24.

Tetrakis(diethylamino)silane: [Si(Net₂)₄]—Yield: 88%; b.p. 120-123° C. at 0.15Torr; ¹H NMR (C₆D₆) δ 1.06 (triplet, 3H), 2.95 (quartet, 2H); ¹³C NMR (C₆D6) δ 15.2, 39.8; IR (neat, cm⁻¹) 2930 (br, s), 1463 (ms), 1375 (s), 1292 (m), 1182 (br, s), 1023 (br, s), 928 (s), 779(ms), 687 (s), 506 (ms); Elemental Anal.: Calcd. C, 60.7%; H, 12.73%; N, 17.7%; Observed. C, 60.46%; H, 13.11%; N, 17.62%; HR-EI M.S.: Calcd. mol. wt. 316.61, observed mol. wt. 316.3022.

Tetrakis(dialkylamino)silanes of the general formula Si(NRR′)₄ (R≠R′=CH₃, CH₂CH₃, or R═R′═CH₃ and CH₂CH₃) were prepared as halide-free, analytically pure compounds whose volatility scales with alkyl group size. The successful syntheses rely on the heavier silicon halides, SiBr₄, and SiI₄. In the case of SiBr₄ incomplete amination with amines bulkier than dimethylamine ultimately led exclusively to BrSi(NR₂)₃, whereas SiI₄ starting material afforded only homoleptic Si(NR₂)₄ whose complete characterization is presented. The tetrakis(dialkylamino)silanes fail to react with alcohols, even at elevated temperatures, and only slowly hydrolyze.

It will be understood by those skilled in the art that any of the tetrakis(dialkylamino)silanes embraced by structural formula (I) above may be prepared similarly.

1. A method of synthesizing a substantially pure homoleptic tetrakis secondary amine derivative of silicon, said derivative being substantially free of halogen and having the formula:
Si(NRR¹)₄
wherein: R and R¹ are the same or different and are substituted or unsubstituted straight or branched chain alkyl, groups having from 1 to 6 carbon atoms,
said method comprising reacting a silicon halide having the formula:
SiX₄
wherein: X is bromine or iodine,
with an excess of a secondary amine having the formula:
HNRR¹
wherein: R and R¹ are as defined as above,
for a time and under conditions sufficient to produce a reaction product mixture containing the desired product, Si(NRR¹)₄.

2. The method of claim 1 wherein said conditions include the substantial presence or absence of a reaction solvent.

3. The method of claim 1 wherein R═R¹=methyl.

4. The method of claim 1 wherein R═R¹=ethyl.

5. The method of claim 1 wherein R=methyl and R¹=ethyl.

6. The method of claim 1 wherein the molar ratio of said secondary amine to said silicon halide is at least 1:1.

7. The method of claim 1 wherein said reaction product mixture also contains the insoluble by-product, 4[X⁻(H₂NR¹R)+] and excess secondary amine and separating said desired product from said reaction product mixture.

8. The method of claim 7 wherein desired product is separated from said reaction product mixture by (1) filtration to remove said [X⁻(H₂NR¹R)+] and (2) distillation to remove said excess secondary amine.

9. The method of claim 8 wherein said distillation is reduced pressure distillation.

10. The substantially pure product Si(NRR¹)₄, containing substantially no halogen.

11. The substantially pure product Si(NRR¹)₄, produced by the method of claim 1.

12. A precursor composition for forming a silicon-containing layer on a substrate, said precursor composition comprising the product of claim 10 or 11.

13. A silicon-containing layer made from the composition of claim 12.

14. An improved substrate having a silicon-containing layer formed thereon using a silicon precursor, the improvement wherein said silicon precursor is substantially pure Si(NRR¹)₄, containing substantially no halogen.

15. The improved substrate of claim 14 wherein said Si(NRR¹)₄, is synthesized by the method of claim 1.

16. The improved substrate of claim 14 or 15 wherein said silicon-containing layer is silicon, silicon nitride, silicon dioxide, doped silicon dioxide, low dielectric constant material or silicon-oxy-nitride.

17. In a method of forming a layer comprising a silicon-containing material using a silicon precursor, the improvement wherein said silicon precursor is substantially pure Si(NRR¹)₄, containing substantially no halogen.

18. The method of claim 17 wherein said pure Si(NRR¹)₄ is synthesized by the method of claim 1.

19. The method of claim 17 comprising chemical vapor deposition.

20. A microelectronic device structure comprising the substrate of claim 16.

21. A microelectronic device structure comprising the substrate of claim 17.

22. A microelectronic device structure of claim 20 or 21 comprising a semiconductor integrated circuit, gate oxide, high k dielectric, low k dielectric, barrier layer, etch stop layer, gate spacer, gate dielectric, silicon nitride barrier layer, semiconductor device, field effect transistor or metal oxide semiconductor capacitor.
